(19) United States
(12) Patent Application Publication
(10) Pub. No.: US 2022/0374730 A1
(43) Pub. Date: Nov. 24, 2022

(54) METHOD FOR ASSIGNING AT LEAST ONE QUERY TRIPLET TO AT LEAST ONE RESPECTIVE CLASS

(71) Applicant: SIEMENS AKTIENGESELLSCHAFT, München (DE)

(72) Inventors: Marcel Hildebrandt, München (DE); Mitchell Joblin, München (DE); Yunpu Ma, München (DE); Martin Ringsquandl, Raubling (DE); Jorge Andres Quintero Serna, München (DE); Thomas Hubauer, Garching bei München (DE)

(21) Appl. No.: 17/767,260

(22) PCT Filed: Oct. 7, 2020
(86) PCT No.: PCT/EP2020/078140

§ 371 Date: Apr. 7, 2022

(30) Foreign Application Priority Data
Oct. 8, 2019 (EP) 19202025.3

(51) Int. Cl. G06N 5/02; G06N 5/04

(52) U.S. Cl. CPC G06N 5/022; G06N 5/045

(57) ABSTRACT

A computer-implemented method and system for assigning at least one query triplet to at least one respective class. The at least one respective class is true or false. The method includes the steps of providing the at least one query triplet and a knowledge graph with a plurality of triples and extracting at least one affirmative argument using reinforcement learning on the basis of the at least one query triplet and the knowledge graph. The at least one affirmative argument indicates that the at least one query triplet is true. The method further includes extracting at least one opposing argument using reinforcement learning on the basis of the at least one query triplet and the knowledge graph. The at least one opposing argument indicates that the at least one query triplet is false. The method further includes assigning the at least one query triplet to the at least one respective class using supervised machine learning depending on the at least two arguments.

### CROSS REFERENCE TO RELATED APPLICATIONS

This present patent document is a § 371 nationalization of PCT Application Serial Number PCT/EP2020/078140 filed Oct. 7, 2020, designating the United States, which is hereby incorporated in its entirety by reference. This patent document also claims the benefit of EP19202025.3 filed on Oct. 8, 2019, which is hereby incorporated in its entirety by reference.

### FIELD

Embodiments relate to a computer-implemented method for assigning at least one query triplet to at least one respective class.

### BACKGROUND

Knowledge graphs are known as graph-structured databases. The elementary unit of a knowledge graph is a triplet subject-predicate-object, often denoted as (head, relation, tail), (s, p, o) or (h, r, t). Each triplet defines one connection between two entities in the knowledge graph.

The knowledge graphs may be used as knowledge base, for example to enhance a search engine's results with information gathered from a variety of sources. The information is presented to users in an info box next to the search results.

Further use cases include fact checking and query answering. Concerning fact checking, the knowledge graphs may be used to integrate information from, for example, gas turbines in terms of maintenance records about, for example, which component was changed and when the component was changed. Concerning query answering, the knowledge graphs may be used to store information about hardware components and historical data about which components were purchased together in order to make intelligent recommendations about future purchase orders.

The knowledge graphs provide an abundant source of rich information. However, the data of the knowledge graphs are often incorrect and inherently incomplete. For example, erroneous data is a result of mistakes made by automated data extraction methods or human errors. Further, many queries of interest are not immediately answerable using the observed facts alone. The identification and correction of erroneous data may be a difficult and time-consuming task since it involves manual inspection of the data by experts.

As currently implemented, hand crafted rules are applied on knowledge graphs. The disadvantage is that the rules are very complex and inapplicable on large amounts of data. The rules do not provide human interpretable justifications for their judgements. In many domains where life critical or mission critical systems utilize knowledge graphs, explainability, and transparence of, for example, fact checking is essential for use acceptance and also due to legal requirements.

### BRIEF DESCRIPTION AND SUMMARY

The scope of the present invention is defined solely by the appended claims and is not affected to any degree by the statements within this summary. The present embodiments may obviate one or more of the drawbacks or limitations in the related art.

Embodiments provide a computer-implemented method for assigning at least one query triplet to at least one respective class in an efficient and reliable manner.

The at least one respective class is true or false. The method includes the steps of providing the at least one query triplet and a knowledge graph with a plurality of triples and extracting at least one affirmative argument using reinforcement learning on the basis of the at least one query triplet and the knowledge graph. The at least one affirmative argument indicates that the at least one query triplet is true. The method further includes extracting at least one opposing argument using reinforcement learning on the basis of the at least one query triplet and the knowledge graph. The at least one opposing argument indicates that the at least one query triplet is false. The method further includes assigning the query triplet to the at least one respective class using supervised machine learning depending on the at least two arguments.

Accordingly, embodiments are directed to a method for assigning a class to a query triplet. In other words, the query triplet is classified in either true or false.

In a first step, the input data is provided or received. The input data includes the query triplet and a knowledge graph.

In the next steps, after reception of the input data, one or more arguments are determined from the knowledge graph reinforcement learning on the basis of the received input data. Thereby, each argument is a path in the knowledge graph, that emanates from the query triplet. Two distinct sets of arguments are determined, affirmative and opposing arguments.

The affirmative arguments are arguments that the query triplet is true. Opposing arguments are arguments that the query triplet is false. In other words, two agents learn a policy conditioned on the query triplet that allows them to identify how to transition from one node in the knowledge graph to an adjacent node.

In a last step, the class is determined using supervised machine learning on the basis of the distinct arguments. Therefore, a trained classification model or machine-learning classifier is applied using machine learning during throughput.

Alternatively, in the training phase, a set of independent input data sets is used as training data set to train the machine learning model, for example a classification model. The classification model is a neural network in an embodiment. The class is used as classification target.

Thus, in other words, the classification model is untrained and used in the training process with a training input data set including training classes, whereas the classifier is used after training in the running system or for the method.

The method provides an improved efficiency and accuracy in determining the class.

Moreover, the resulting output data is more reliable and less error-prone compared to existing methods. This way, the output data and, for example, the query triplet may serve as improved basis for more efficient subsequent processing steps, that are built on the reliable output data with e.g., the class. For example, the knowledge graph may be extended with the query triplet, see further below.

The method provides for fact checking and query answering in knowledge graphs based on debate dynamics. In other words, probabilistic inference is applied on knowledge graphs providing explanations in terms of proofs in the underlying knowledge graph.

In one aspect the supervised machine learning is a learning-based approach selected from the group of a neural network, a support vector machine, logistic regression, linear regression, and/or a random forest. Accordingly, the method may be applied in a flexible manner according to the specific application case, underlying technical system and user requirements. Neural networks have proven to be advantageous since they provide high reliability in recognition, may be trained flexibly, and offer fast evaluation.

In another aspect the method further includes the step of performing at least one action.

In another aspect, performing the at least one action depending on at least one determined score. The at least one score is determined by using machine learning on the basis of the at least one query triplet and the knowledge graph and the at least one determined score is assigned to the query triplet.

In another aspect the at least one action is performed, if the at least one score equals or exceeds a predefined threshold.

In another aspect the at least one action is selected from the group, including outputting the at least one query triplet, the knowledge graph, the at least two arguments, the at least one class, the at least one score and/or any other related notification, storing the at least one query triplet, the knowledge graph, the at least two arguments, the at least one class, the at least one score and/or any other related notification, displaying the at least one query triplet, the knowledge graph, the at least two arguments, the at least one class, the at least one score and/or any other related notification, transmitting the at least one query triplet, the knowledge graph, the at least two arguments, the at least one class, the at least one score and/or any other related notification to a computing unit for further processing, and evaluating the at least one query triplet with the assigned at least one class and/or score.

Accordingly, the input data, data of intermediate method steps and/or resulting output data may be further handled. The output data may be the query triplet with the assigned class and/or score. One or more actions may be performed. The action may be equally referred to as measure.

The actions may be triggered depending on the predefined threshold, according to which, the score has to meet and/or exceed a predetermined threshold. These actions may be performed by one or more computing units of the technical system. The actions may be performed gradually or simultaneously. Actions include e.g., storing and processing steps. The advantage is that appropriate actions may be performed in a timely manner.

For example, output data and/or a related notification may be displayed to a user by a display unit, for example the most likely class or classes with scores exceeding a predetermined threshold. Further, the user may evaluate the provided output data.

In another aspect the method further includes the step of confirming the at least one query triplet or overwriting the at least one query triplet depending on the evaluation.

In another aspect the evaluation and/or confirmation is performed by a user.

Accordingly, an evaluation may be performed on the basis of the provided output data.

The user may either confirm and thus accept the query triplet or reject and thus overwrite or adapt the query triplet. Alternatively, the evaluation may be performed automatically by a computing unit using evaluation software. This way, the reliability of the output data is further improved. The user interaction allows for an improved reliability since expert knowledge may be considered.

In another aspect the method further includes the step of extending the knowledge graph with the query triplet after confirmation. Accordingly, the confirmed query triplet may be added to the knowledge graph after performed evaluation and solely after confirmation. This way, the knowledge graph is enriched with reliable data.

Embodiments provide a computer program product directly loadable into an internal memory of a computer, including software code portions for performing the steps according to the aforementioned method when said computer program product is running on a computer.

Embodiments provide a technical system for assigning at least one query triplet to at least one respective class. The at least one respective class is true or false. The technical system includes a receiving unit for providing the at least one query triplet and a knowledge graph with a plurality of triples and an extracting unit configured for extracting at least one affirmative argument using reinforcement learning on the basis of the at least one query triplet and the knowledge graph. The at least one affirmative argument indicates that the at least one query triplet is true. The extracting unit is further configured for extracting at least one opposing argument using reinforcement learning on the basis of the at least one query triplet and the knowledge graph. The at least one opposing argument indicates that the at least one query triplet is false. the technical system further includes a classification unit for assigning the at least one query triplet to the at least one respective class using supervised machine learning depending on the at least two arguments.

The units may be realized as any devices, or any modules, for computing, for example for executing a software, an app, or an algorithm. For example, the units may consist of or include a central processing unit (CPU) and/or a memory operatively connected to the CPU. The units may also include an array of CPUs, an array of graphical processing units (GPUs), at least one application-specific integrated circuit (ASIC), at least one field-programmable gate array, or any combination of the foregoing. The units may include at least one module that in turn may include software and/or hardware. Some, or even all, modules of the units may be implemented by a cloud computing platform.

### BRIEF DESCRIPTION OF THE FIGURES

In the following detailed description, embodiments are further described with reference to the following figures:

FIG. 1 depicts a flowchart of the method according to an embodiment.

FIG. 2 depicts a debate according to an embodiment.

FIG. 3 depicts a method according to an embodiment.

### DETAILED DESCRIPTION

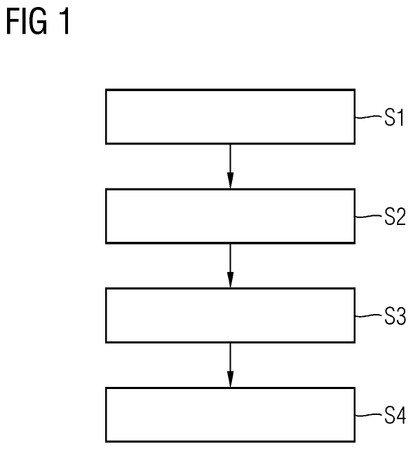

FIG. 1 depicts a flowchart of the method. The method is for assigning at least one query triplet to at least one respective class, wherein the at least one class is true or false. The method includes the following steps S1 to S4. In a first step the at least one query triplet 10 and a knowledge graph with a plurality of triples in provided S1. The first step may be performed by a receiving unit. In a second step at least one affirmative argument 20 using reinforcement learning on the basis of the at least one query triplet 10 and the knowledge graph is extracted S2. The at least one affirmative argument indicates that the at least one query triplet 10 is true. The second step may be performed by an extracting unit. In a third step at least one opposing argument 30 using reinforcement learning on the basis of the at least one query triplet 10 and the knowledge graph is extracted S3. The at least one opposing argument indicates that the at least one query triplet 10 is false. The third step may be performed by an extracting unit. In a last step the query triplet 10 is assigned to the at least one class using supervised machine learning depending on the at least two arguments 20, 30, S4. The last step may be performed by a classification unit. In other words, the query triplet 10 is assigned to true or false.

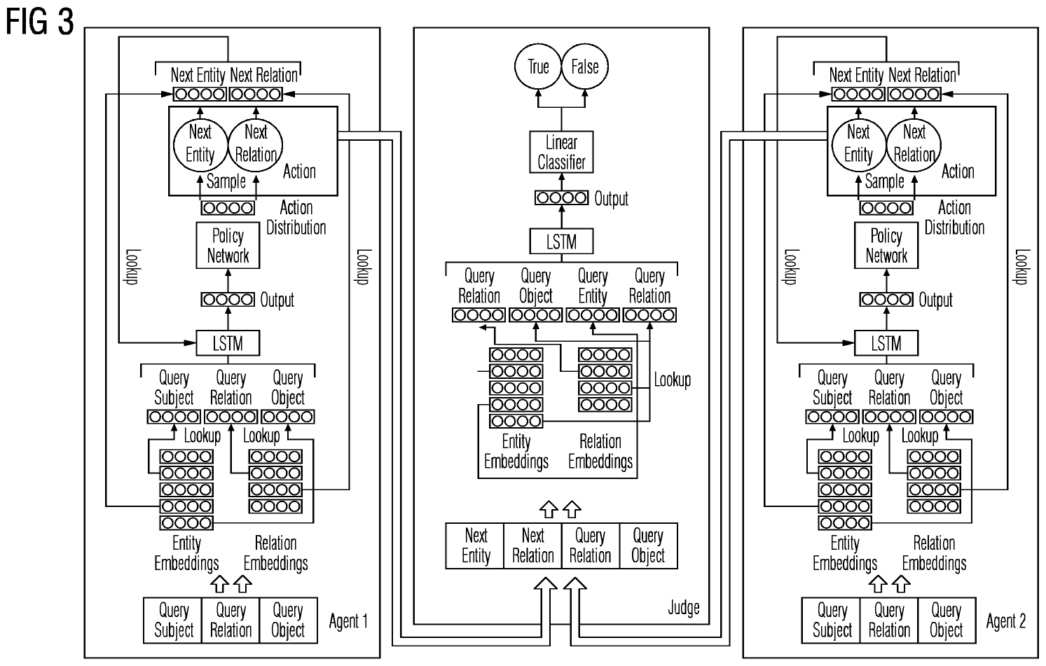

The extracting units are intelligent agents according to an embodiment. The classification unit is a supervised judger or classifier according to an embodiment. FIG. 3 shows the method according to an embodiment with the two agents and the classifier.

Intelligent Agents

One agent is designated as arguing for the affirmative position and the second agent is designated as arguing for the opposing position. Arguments 20, 30 are phrased in terms of paths present in the knowledge graph that emanate from the query triplet 10. Each agent constructs arguments 20, 30, that are then evaluated by the classifier. The number of arguments 20, 30 may be predefined and thus fixed.

Classifier

The classifier evaluates the provided affirmative and opposing arguments 20, 30 and their respective quality. Further, the classifier assigns a winning party to the query triplet 10 on the basis of these arguments 20, 30. The resulting prediction may be generated by adopting the winning party's position.

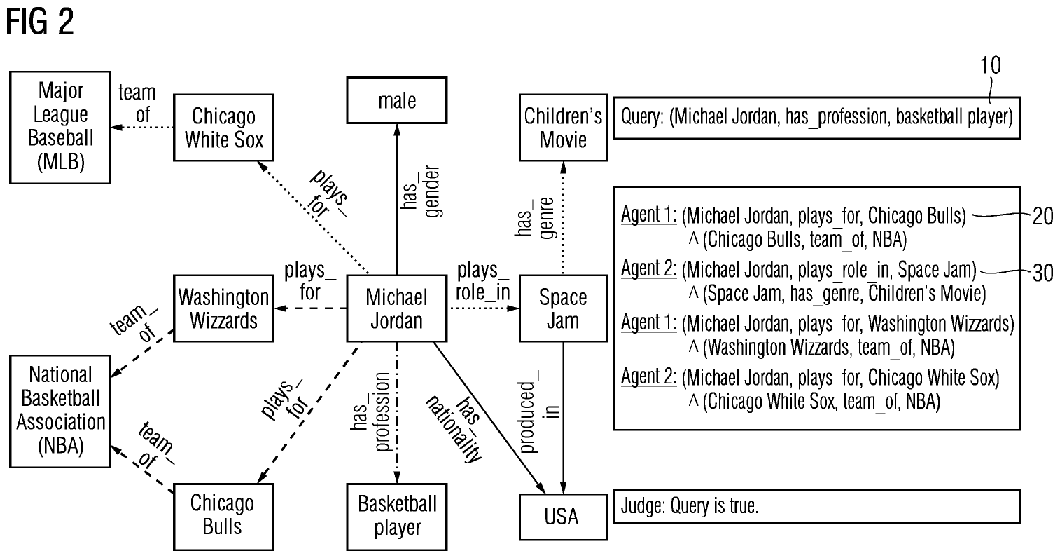

FIG. 2 illustrates a debate between the two intelligent agents according to an embodiment. The intelligent agents debate whether Michael Jordan is a professional basketball player. The agent 1 extracts affirmative arguments 20 from the knowledge graph that the fact is true, whereas agent 2 argues that the fact is false. In this example, the classifier decides that Michael Jordan is a professional basketball player based on the arguments 20, 30. In other words, the query triplet 10 is classified as true. The query triplet may be added to the knowledge graph, for example after further confirmation.

In principle, the two agents learn a policy conditioned on the query triplet that allows them to identify how to transition from one node in the knowledge graph to an adjacent node (the process of constructing an argument) to convince the classifier of their beliefs regarding the query triplet. More precisely, the two agents traverse the knowledge graph sequentially and select the next hop based on a policy that takes previous transitions and the query triplet into account. All paths are processed by the classifier that tries to distinguish between true and false triples. While the parameters of the classifier are fitted in a supervised fashion, both agents are trained to navigate through the knowledge graph using reinforcement learning. The transitions are added to the current path extending the argument.

Contrary to existing methods, the aforementioned method is interpretable because the arguments allow the user to get an understanding of the decision of the classifier.

Moreover, in contrast to one-way black-box configurations, comprehensible machine learning methods allow to build systems where both machines and users may interact with each other.

Moreover, mining evidence for both the thesis and the antithesis may make the classifier more robust towards contradictory evidence or corrupted data. Last but not least, the use of paths in the knowledge graphs for argumentation opens up a straightforward way to address knowledge dynamics and more specifically fact retraction, as argument based on this fact may be identified easily.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A Method for assigning at least one query triplet to at least one respective class, wherein the at least one respective class is true or false, the method comprising:
providing the at least one query triplet and a knowledge graph with a plurality of triples;
extracting at least one affirmative argument using reinforcement learning on a basis of the at least one query triplet and the knowledge graph, wherein the at least one affirmative argument indicates that the at least one query triplet is true;
extracting at least one opposing argument using reinforcement learning on a basis of the at least one query triplet and the knowledge graph, wherein the at least one opposing argument indicates that the at least one query triplet is false; and
assigning the at least one query triplet to the at least one respective class using supervised machine learning depending on the at least one affirmative argument and the at least one opposing argument.

2. The Method of claim 1, wherein the supervised machine learning is a learning-based approach comprising at least one of a neural network, a support vector machine, logistic regression, linear regression, or a random forest.

3. The Method of claim 1, further comprising:
performing at least one action.

4. The Method of claim 3, further comprising performing the at least one action depending on at least one determined score, wherein the at least one score is determined by using machine learning on a basis of the at least one query triplet and the knowledge graph and
the at least one determined score is assigned to the query triplet.

5. The Method of claim 4, wherein the at least one action is performed when the at least one score equals or exceeds a predefined threshold.

6. The Method of claim 4, wherein the at least one action comprises at least one of:
outputting at least one of the at least one query triplet, the knowledge graph, the at least one affirmative argument and the at least one opposing argument, the at least one class, the at least one score, or any other related notification;
storing at least one of the at least one query triplet, the knowledge graph, the at least one affirmative argument and the at least one opposing argument, the at least one class, the at least one score, or any other related notification;
displaying at least on of the at least one query triplet, the knowledge graph, the at least one affirmative argument and the at least one opposing argument, the at least one class, the at least one score, or any other related notification; or
transmitting the at least one query triplet, the knowledge graph, the at least one affirmative argument and the at least one opposing argument, the at least one class, the at least one score, or any other related notification to a computing unit for further processing; or
valuating the at least one query triplet with the assigned at least one class, the score, or at least one class and the score.

7. The Method of claim 6, wherein the at least one triplet is evaluated, wherein the method further comprises:
confirming the at least one query triplet or over-writing the at least one query triplet depending on the evaluation.

8. The Method of claim 7, wherein the evaluation, confirmation, or evaluation and confirmation is performed by a user.

9. The Method of according to claim 8, wherein the method further comprises:
extending the knowledge graph with the query triplet after confirmation.

10. (canceled)

11. A System for assigning at least one query triplet to at least one respective class, wherein the at least one respective class is true or false, the system comprising:
a Receiving unit configured to provide the at least one query triplet and a knowledge graph with a plurality of triples;
an Extracting unit configured to extract at least one affirmative argument using reinforcement learning on a basis of the at least one query triplet and the knowledge graph, wherein the at least one affirmative argument indicates that the at least one query triplet is true;
the Extracting unit further configured to extract at least one opposing argument using reinforcement learning on a basis of the at least one query triplet and the knowledge graph, wherein the at least one opposing argument indicates that the at least one query triplet is false; and
a Classification unit configured to assign the at least one query triplet to the at least one respective class using supervised machine learning depending on the at least one affirmative argument and the at least one opposing argument.

12. A computer program product directly loadable into an internal memory of a computer, comprising software code portions that when run on a computer are configured to:
provide at least one query triplet and a knowledge graph with a plurality of triples;
extract at least one affirmative argument using reinforcement learning based on the at least one query triplet and the knowledge graph, wherein the at least one affirmative argument indicates that the at least one query triplet is true;
extract at least one opposing argument using reinforcement learning based on the at least one query triplet and the knowledge graph, wherein the at least one opposing argument indicates that the at least one query triplet is false; and
assign the at least one query triplet to at least one respective class using supervised machine learning depending on the at least one affirmative argument and the at least one opposing argument.
